(19) United States
(12) Patent Application Publication
(10) Pub. No.: US 2025/0116014 A1
(43) Pub. Date: Apr. 10, 2025

(54) CHROMIUM ALLOY CONTAINER AND METAL-SUPPORTED ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/919,559

(22) Filed: Oct. 18, 2024

Related U.S. Application Data
(63) Continuation of application No. PCT/JP2023/036374, filed on Oct. 5, 2023.

(51) Int. Cl. C25B 9/60; C22C 27/06

(52) U.S. Cl. CPC C25B 9/60; C22C 27/06

(57) ABSTRACT

A chromium alloy container has an internal space. The chromium alloy container includes a first alloy member constituted by an alloy containing chromium, a second alloy member constituted by an alloy containing chromium, and an interposing portion interposed between the first alloy member and the second alloy member. The interposing portion includes an oxide adhesion layer constituted by an oxide containing chromium as a main component, and a metal connection portion embedded in the oxide adhesion layer and connecting the first alloy member and the second alloy member to each other.

### CROSS-REFERENCE TO RELATED APPLICATION

This is a continuation of PCT/JP2023/036374, filed Oct. 5, 2023, the entire contents of which are hereby incorporated by reference.

### TECHNICAL FIELD

The present invention relates to a chromium alloy container and a metal-supported electrochemical cell.

### BACKGROUND ART

A chromium alloy container for housing a fuel cell is disclosed in JP 2015-156352A. The chromium alloy container includes a first interconnector, a second interconnector, a separator, an anode frame, and a glass seal.

The first interconnector is connected to an air electrode of the fuel cell. The second interconnector is connected to an anode current collecting layer of the fuel cell. The separator is connected to a solid electrolyte of the fuel cell and separates flow paths for fuel gas and oxidant gas. The anode frame is disposed between the separator and the second interconnector. The glass seal adheres the first interconnector and the separator to each other.

The first interconnector, the second interconnector, the separator, and the anode frame are each constituted by a chromium alloy (e.g., SUS430 or SUS444). The glass seal is constituted by a glass material.

### SUMMARY

In the chromium alloy container described in JP 2015-156352A, when the chromium contained in the first interconnector and the separator diffuses into the glass seal, the composition of the glass seal changes, and the strength is likely to decrease. As a result, the glass seal may deform or crack, thus making it impossible to maintain bonding between alloy members for a long period of time. This is not limited to containers that house fuel cells, and is a common problem for chromium alloy containers in general.

An object of the present invention is to provide a chromium alloy container and a metal-supported electrochemical cell in which bonding between alloy members can be maintained for a long period of time.

A chromium alloy container according to a first aspect of the present invention has an internal space. The chromium alloy container includes a first alloy member constituted by an alloy containing chromium, a second alloy member constituted by an alloy containing chromium, and an interposing portion interposed between the first alloy member and the second alloy member. The interposing portion includes an oxide adhesion layer constituted by an oxide containing chromium as a main component, and a metal connection portion embedded in the oxide adhesion layer and connecting the first alloy member and the second alloy member to each other.

A chromium alloy container according to a second aspect of the present invention is the chromium alloy container according to the first aspect, wherein the metal connection portion contains, as a main component, an element corresponding to a main component of at least either the first alloy member or the second alloy member.

A chromium alloy container according to a third aspect of the present invention is the chromium alloy container according to the first or second aspect, wherein the metal connection portion contains chromium.

A chromium alloy container according to a fourth aspect of the present invention is the chromium alloy container according to any of the first to third aspects, wherein a ratio of a smallest width of the metal connection portion in a planar direction to a thickness of the oxide adhesion layer in a thickness direction is 0.3 or more.

A chromium alloy container according to a fifth aspect of the present invention is the chromium alloy container according to any of the first to fourth aspects, wherein a ratio of a longest distance between the metal connection portions in a planar direction to a thickness of the oxide adhesion layer in a thickness direction is 20 or more.

A chromium alloy container according to a sixth aspect of the present invention is the chromium alloy container according to any of the first to fifth aspects, wherein a ratio of a thickness of the first alloy member or the second alloy member in a thickness direction to a smallest width of the metal connection portion in a planar direction is 50 or more.

A chromium alloy container according to a seventh aspect of the present invention is the chromium alloy container according to any of the first to sixth aspects, wherein a ratio of a thickness of the first alloy member or the second alloy member in a thickness direction to a smallest width of the metal connection portion in a planar direction is 2000 or less.

A chromium alloy container according to an eighth aspect of the present invention is the chromium alloy container according to any of the first to seventh aspects, wherein a chromium content among metal elements in the oxide adhesion layer is 50 mol % or more.

A chromium alloy container according to a ninth aspect of the present invention is the chromium alloy container according to any of the first to eighth aspects, wherein the oxide adhesion layer is constituted by at least either chromium oxide or chromium manganese oxide.

A chromium alloy container according to a tenth aspect of the present invention is the chromium alloy container according to any of the first to ninth aspects, wherein the oxide adhesion layer is crystalline.

A chromium alloy container according to an eleventh aspect of the present invention is the chromium alloy container according to the tenth aspect, wherein the oxide adhesion layer has a spinel type crystal structure or a corundum type crystal structure.

A chromium alloy container according to a twelfth aspect of the present invention is the chromium alloy container according to any of the first to eleventh aspects, wherein the interposing portion is a seal for sealing the internal space.

A chromium alloy container according to a thirteenth aspect of the present invention is the chromium alloy container according to any of the first to twelfth aspects, wherein the second alloy member has an embossed portion in contact with the first alloy member. The interposing portion adheres the embossed portion to the first alloy member.

A metal-supported electrochemical cell according to a fourteenth aspect of the present invention includes the chromium alloy container according to any of the first to thirteenth aspects, and a cell body portion disposed on the chromium alloy container. The first alloy member has a plurality of communication holes in communication with the internal space. The cell body portion is disposed on the first alloy member in such a manner as to cover the plurality of communication holes.

According to the present invention, it is possible to provide a chromium alloy container and a metal-supported electrochemical cell in which bonding between alloy members can be maintained for a long period of time.

### BRIEF DESCRIPTION OF DRAWINGS

FIG. 1 is a plan view of an electrolysis cell according to a first embodiment.

FIG. 2 is a cross-sectional view taken along line A-A in FIG. 1.

FIG. 3 is an enlarged view of a portion of FIG. 2.

FIG. 4 is a cross-sectional view of an electrolysis cell according to a second embodiment.

FIG. 5 is an enlarged view of a portion of FIG. 4.

### DESCRIPTION OF EMBODIMENTS

### 1. First Embodiment

### (Electrolysis Cell 1)

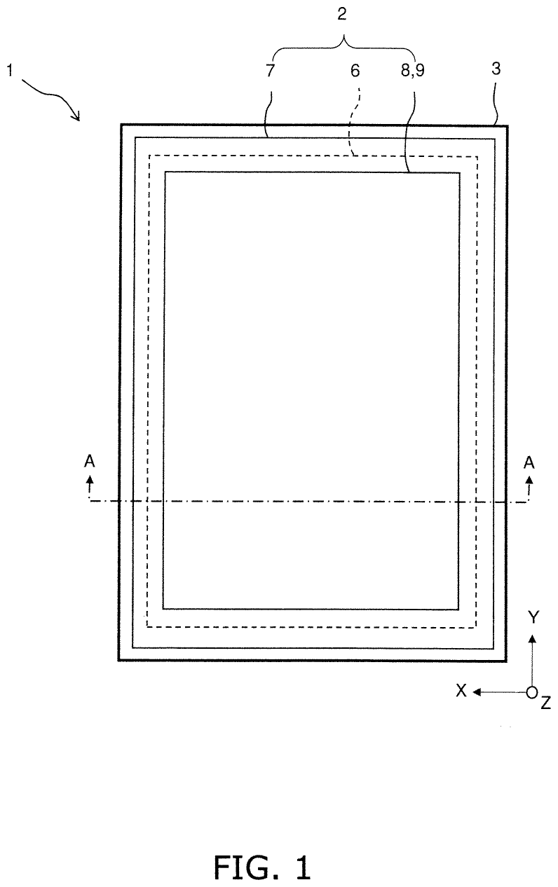

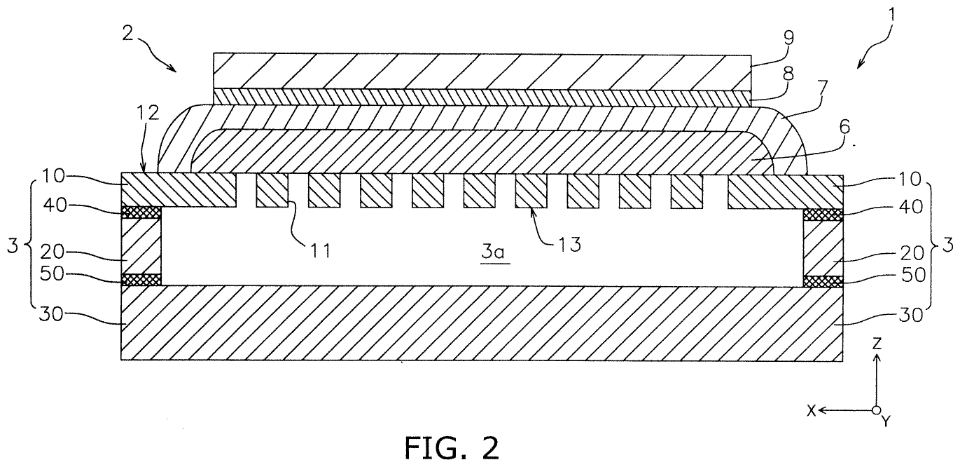

FIG. 1 is a plan view of an electrolysis cell 1 according to a first embodiment. FIG. 2 is a cross-sectional view taken along line A-A in FIG. 1.

The electrolysis cell 1 is an example of a “metal-supported electrochemical cell” according to the present invention.

The electrolysis cell 1 is shaped as a plate extending in an X-axis direction and a Y-axis direction. In the present embodiment, the electrolysis cell 1 is shaped as a rectangle extending in the Y-axis direction when viewed in a plan view from a Z-axis direction perpendicular to the X-axis direction and the Y-axis direction. However, the planar shape of the electrolysis cell 1 is not particularly limited, and may be a polygon other than a rectangle, such as an ellipse, a circle, or the like.

As shown in FIGS. 1 and 2, the electrolysis cell 1 includes a cell body portion 2 and a chromium alloy container 3.

### (Cell Body Portion 2)

The cell body portion 2 is disposed on the chromium alloy container 3. The cell body portion 2 is supported by a later-described metal support 10 of the chromium alloy container 3. The cell body portion 2 includes a hydrogen electrode 6 (cathode), an electrolyte 7, a reaction prevention layer 8, and an oxygen electrode 9 (anode).

The hydrogen electrode 6, the electrolyte 7, the reaction prevention layer 8, and the oxygen electrode 9 are stacked in this order from the chromium alloy container 3 side in the Z-axis direction. The hydrogen electrode 6, the electrolyte 7, and the oxygen electrode 9 are essential components, whereas the reaction prevention layer 8 is an optional component.

### [Hydrogen Electrode 6]

The hydrogen electrode 6 is disposed on a first main surface 12 of the metal support 10.

A raw material gas is supplied to the hydrogen electrode 6 through supply holes 11 in the metal support 10. The raw material gas contains at least water vapor (H₂O).

When the raw material gas contains only H₂O, the hydrogen electrode 6 produces H₂ from the raw material gas in accordance with water electrolysis, which is the electrochemical reaction shown in the following formula (1).

Hydrogen electrode 6: H₂O+2e⁻→H₂+O²⁻ (1)

When the raw material gas contains CO₂ in addition to H₂O, the hydrogen electrode 6 produces H₂, CO, and O²⁻ from the raw material gas in accordance with co-electrolysis, which are the co-electrochemical reactions shown in the following formulas (2), (3), and (4).

Hydrogen electrode 6: CO₂+H₂O+4e⁻→CO+H₂+2O²⁻ (2)

H₂O electrochemical reaction: H₂O+2e⁻→H₂+O²⁻ (3)

CO₂ electrochemical reaction: CO₂+2e⁻→CO+O²⁻ (4)

H₂ produced in the hydrogen electrode 6 flows out from the supply holes 11 of the metal support 10 into a later-described internal space 3a.

The hydrogen electrode 6 is a porous body that has electronic conductivity. The hydrogen electrode 6 contains nickel (Ni). In the case of co-electrolysis, Ni functions as an electronic conductor, and also functions as a thermal catalyst that promotes the thermal reaction between the produced H₂ and the CO₂ contained in the raw material gas to maintain an appropriate gas composition for methanation, Fischer-Tropsch (FT) synthesis, and the like. The Ni contained in the hydrogen electrode 6 is essentially present in the form of metal Ni during operation of the electrolysis cell 1, but may also partially be present in the form of nickel oxide (NiO).

The hydrogen electrode 6 may contain an ion conductive material. Examples of the ion conductive material that can be used include yttria-stabilized zirconia (YSZ), calcia-stabilized zirconia (CSZ), scandia-stabilized zirconia (ScSZ), gadolinium-doped ceria (GDC), samarium-doped ceria (SDC), (La,Sr)(Cr,Mn)O₃, (La,Sr)TiO₃, Sr₂(Fe,Mo)₂O₆, (La,Sr)VO₃, (La,Sr)FeO₃, and mixed materials containing two or more of these.

The thickness of the hydrogen electrode 6 is not particularly limited, but can be, for example, 1 μm or more and 100 μm or less. The value of the thermal expansion coefficient of the hydrogen electrode 6 is not particularly limited, but can be, for example, 12×10⁻⁶/° C. or more and 20×10⁻⁶/° C. or less.

The method for forming the hydrogen electrode 6 is not particularly limited, and may be a firing method, a spray coating method (such as a thermal spray method, an aerosol deposition method, an aerosol gas deposition method, a powder jet deposition method, a particle jet deposition method, or a cold spray method), a PVD method (such as a sputtering method or a pulsed laser deposition method), or a CVD method, for example.

### [Electrolyte 7]

The electrolyte 7 is formed on the hydrogen electrode 6. The electrolyte 7 is disposed between the hydrogen electrode 6 and the oxygen electrode 9. In the present embodiment, the electrolyte 7 is sandwiched between the hydrogen electrode 6 and the reaction prevention layer 8 and is connected to both of them.

The electrolyte 7 covers the hydrogen electrode 6 and also covers the region of the first main surface 12 of the metal support 10 that is exposed from the hydrogen electrode 6.

The electrolyte 7 is a dense body that has oxide ion conductivity. The electrolyte 7 transfers O²⁻ produced at the hydrogen electrode 6 toward the oxygen electrode 9. The electrolyte 7 is constituted by an oxide ion conductive material. The electrolyte 7 can be constituted by, for example, YSZ, GDC, ScSZ, SDC, LSGM (lanthanum gallate), or the like, with YSZ being particularly preferable.

The thickness of the electrolyte 7 is not particularly limited, but can be, for example, 1 μm or more and 100 μm or less. The value of the thermal expansion coefficient of the electrolyte 7 is not particularly limited, but can be, for example, 10×10⁻⁶/° C. or more and 12×10⁻⁶/° C. or less.

The method for forming the electrolyte 7 is not particularly limited, and a firing method, a spray coating method, a PVD method, a CVD method, or the like can be used.

### [Reaction Prevention Layer 8]

The reaction prevention layer 8 is disposed between the electrolyte 7 and the oxygen electrode 9. The reaction prevention layer 8 is disposed on the side of the electrolyte 7 opposite to the hydrogen electrode 6 side. The reaction prevention layer 8 suppresses the formation of a layer with high electrical resistance caused by constituent elements of the electrolyte 7 reacting with constituent elements of the oxygen electrode 9.

The reaction prevention layer 8 is constituted by an oxide ion conductive material. The reaction prevention layer 8 can be constituted by GDC, SDC, or the like.

The porosity of the reaction prevention layer 8 is not particularly limited, but can be, for example, 0.1% or more and 50% or less. The thickness of the reaction prevention layer 8 is not particularly limited, but may be, for example, 1 μm or more and 50 μm or less.

The method for forming the reaction prevention layer 8 is not particularly limited, and a firing method, a spray coating method, a PVD method, a CVD method, or the like can be used.

### [Oxygen Electrode 9]

The oxygen electrode 9 is disposed on the side of the electrolyte 7 opposite to the hydrogen electrode 6 side. In the present embodiment, the reaction prevention layer 8 is disposed between the electrolyte 7 and the oxygen electrode 9, and therefore the oxygen electrode 9 is connected to the reaction prevention layer 8. When the reaction prevention layer 8 is not disposed between the electrolyte 7 and the oxygen electrode 9, the oxygen electrode 9 is connected to the electrolyte 7.

The oxygen electrode 9 produces O₂ from O²⁻ transferred from the hydrogen electrode 6 via the electrolyte 7 in accordance with the chemical reaction of the following formula (5).

Oxygen electrode 9: 2O²⁻→O₂+4e⁻ (5)

The oxygen electrode 9 is a porous body that has oxide ion conductivity and electronic conductivity. The oxygen electrode 9 can be formed of a composite material containing an oxide ion conductive material (such as GDC) and one or more of (La,Sr)(Co,Fe)O₃, (La,Sr)FeO₃, La(Ni,Fe)O₃, (La,Sr)CoO₃, and (Sm,Sr)CoO₃.

The porosity of the oxygen electrode 9 is not particularly limited, but can be, for example, 20% or more and 60% or less. The thickness of the oxygen electrode 9 is not particularly limited, but can be, for example, 1 μm or more and 100 μm or less.

The method for forming the oxygen electrode 9 is not particularly limited, and a firing method, a spray coating method, a PVD method, a CVD method, or the like can be used.

### (Chromium Alloy Container 3)

The chromium alloy container 3 includes the internal space 3a through which the raw material gas supplied to the hydrogen electrode 6 and the reducing gas (H₂ in the present embodiment) produced in the hydrogen electrode 6 flow.

In the present embodiment, the chromium alloy container 3 includes the metal support 10, a frame 20, an interconnector 30, a first sealing portion 40, and a second sealing portion 50. The internal space 3a is a space surrounded by the metal support 10, the frame 20, the interconnector 30, the first sealing portion 40, and the second sealing portion 50.

In the present embodiment, either the metal support 10 or the frame 20 is an example of the “first alloy member” according to the present invention, and the other one is an example of the “second alloy member” according to the present invention. Also, in the present embodiment, either the frame 20 or the interconnector 30 is an example of the “first alloy member” according to the present invention, and the other one is an example of the “second alloy member” according to the present invention. The first sealing portion 40 and the second sealing portion 50 are each an example of the “interposing portion” according to the present invention.

### [Metal Support 10]

The metal support 10 supports the cell body portion 2. In the present embodiment, the metal support 10 is formed in a plate shape. The metal support 10 may be shaped as a flat plate or a curved plate.

The metal support 10 is only required to be able to support the cell body portion 2, and the thickness is not particularly limited, but can be, for example, 0.1 mm or more and 2.0 mm or less.

As shown in FIG. 2, the metal support 10 includes the supply holes 11, the first main surface 12, and the second main surface 13.

The supply holes 11 pass through the metal support 10 from the first main surface 12 to the second main surface 13. The supply holes 11 are open at both the first main surface 12 and the second main surface 13. The supply holes 11 are covered by the cell body portion 2. Specifically, the openings of the supply holes 11 on the first main surface 12 side are covered by the hydrogen electrode 6. The openings of the supply holes 11 on the second main surface 13 side are in communication with the internal space 3a.

The supply holes 11 can be formed by mechanical processing (e.g., punching), laser processing, chemical processing (e.g., etching), or the like.

In the present embodiment, the supply holes 11 extend straight along the Z-axis direction. However, the supply holes 11 may be inclined with respect to the Z-axis direction, and do not need to be linear. Moreover, the supply holes 11 may be connected to each other.

The first main surface 12 is provided on the side opposite to the second main surface 13. The cell body portion 2 is disposed on the first main surface 12. The frame 20 is joined to the second main surface 13 via the first sealing portion 40.

The metal support 10 is constituted by an alloy containing Cr (chromium). Examples of such alloys include Fe—Cr alloy steel (such as stainless steel) and Ni—Cr alloy steel. The Cr content in the metal support 10 is not particularly limited, but can be set to 4 mass % or more and 30 mass % or less.

The metal support 10 may contain Ti (titanium) and/or Zr (zirconium). The Ti content in the metal support 10 is not particularly limited, but can be set to 0.01 mol % or more and 1.0 mol % or less. The Zr content in the metal support 10 is not particularly limited, but can be set to 0.01 mol % or more and 0.4 mol % or less. The metal support 10 may contain Ti as TiO₂ (titania) and Zr as ZrO₂ (zirconia).

### [Frame 20]

The frame 20 is a spacer for forming the internal space 3a. In the present embodiment, the frame 20 is formed in an annular shape.

The frame 20 is joined to the metal support 10 via the first sealing portion 40, and is joined to the interconnector 30 via the second sealing portion 50.

The thickness of the frame 20 is not particularly limited, but may be, for example, 0.1 mm or more and 2.0 mm or less.

The frame 20 is constituted by an alloy containing Cr. Examples of such alloys include Fe—Cr alloy steel and Ni—Cr alloy steel. The Cr content in the frame 20 is not particularly limited, but can be set to 4 mass % or more and 30 mass % or less. The composition of the frame 20 may be the same as or different from that of the metal support 10.

### [Interconnector 30]

The interconnector 30 is disposed on the side of the frame 20 opposite to the metal support 10 side. The interconnector 30 is a member for electrically connecting the electrolysis cell 1 to an external power source or another electrolysis cell.

In the present embodiment, the interconnector 30 is formed in a plate shape. The interconnector 30 may be shaped as a flat plate or a curved plate.

The interconnector 30 is joined to the frame 20 via the second sealing portion 50.

The thickness of the interconnector 30 is not particularly limited, but can be, for example, 0.1 mm or more and 2.0 mm or less.

The interconnector 30 is constituted by an alloy containing Cr. Examples of such alloys include Fe—Cr alloy steel and Ni—Cr alloy steel. The Cr content in the interconnector 30 is not particularly limited, but can be set to 4 mass % or more and 30 mass % or less. The composition of the interconnector 30 may be the same as or different from that of the metal support 10. The composition of the interconnector 30 may be the same as or different from that of the frame 20.

### [First Sealing Portion 40]

The first sealing portion 40 is disposed between the metal support 10 and the frame 20. The first sealing portion 40 is joined to both the metal support 10 and the frame 20.

The first sealing portion 40 is formed in an annular shape. The first sealing portion 40 seals the gap between the metal support 10 and the frame 20. This prevents the raw material gas supplied to the hydrogen electrode 6 and the reducing gas produced in the hydrogen electrode 6 from leaking to the outside through the gap between the metal support 10 and the frame 20. The detailed configuration of the first sealing portion 40 will be described later.

### [Second Sealing Portion 50]

The second sealing portion 50 is disposed between the frame 20 and the interconnector 30. The second sealing portion 50 is joined to both the frame 20 and the interconnector 30.

The second sealing portion 50 is formed in an annular shape. The second sealing portion 50 seals the gap between the frame 20 and the interconnector 30. This prevents the raw material gas supplied to the hydrogen electrode 6 and the reducing gas produced in the hydrogen electrode 6 from leaking to the outside through the gap between the frame 20 and the interconnector 30.

The configuration of the second sealing portion 50 is the same as the configuration of the first sealing portion 40, which will be described next, and therefore, in the present embodiment, a description will not be given for the configuration of the second sealing portion 50.

### (Detailed Configuration of First Sealing Portion 40)

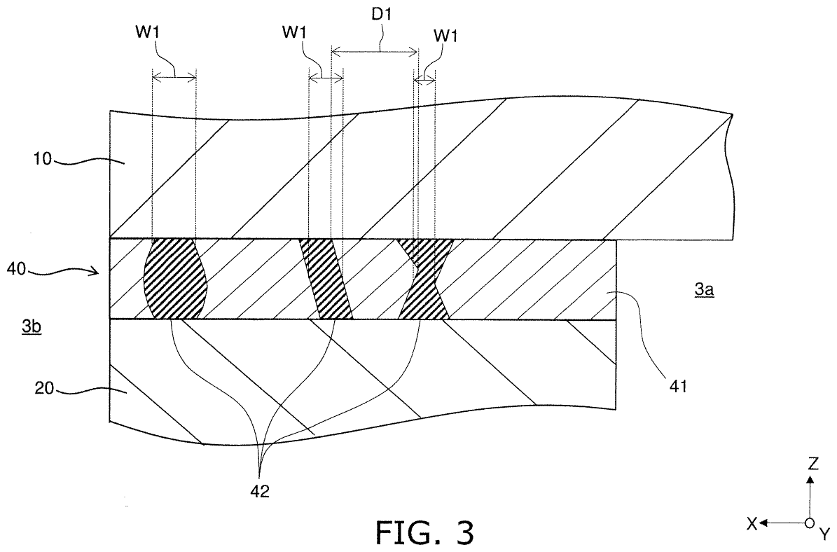

FIG. 3 is an enlarged view of a portion of FIG. 2. A cross section of the first sealing portion 40 is shown in FIG. 3. The cross section illustrated in FIG. 3 is perpendicular to the first main surface 12 of the metal support 10.

The first sealing portion 40 includes an oxide adhesion layer 41 and metal connection portions 42.

### [Oxide Adhesion Layer 41]

The oxide adhesion layer 41 is disposed between the metal support 10 and the frame 20. The oxide adhesion layer 41 is sandwiched between the metal support 10 and the frame 20. The oxide adhesion layer 41 is formed in an annular shape so as to surround the internal space 3a. The oxide adhesion layer 41 is exposed to the internal space 3a.

The oxide adhesion layer 41 is constituted by an oxide containing Cr as a main component (hereinafter, abbreviated as “Cr oxide”). This makes it possible to suppress the diffusion of Cr from the metal support 10 and the frame 20 to the oxide adhesion layer 41 during the manufacture and operation of the electrolysis cell 1. Furthermore, even if Cr diffuses from the metal support 10 and the frame 20 to the oxide adhesion layer 41, the effect on the composition of the oxide adhesion layer 41 is small, thus making it possible to suppress a decrease in the strength of the oxide adhesion layer 41. Furthermore, since the metal support 10, the frame 20, and the oxide adhesion layer 41 all contain Cr, the bond therebetween can be improved. Therefore, the bond between the metal support 10 and the frame 20 can be maintained for a long period of time.

In the present embodiment, the term “containing Cr as a main component” means that when the composition of the Cr oxide constituting the oxide adhesion layer 41 is analyzed using an energy dispersive spectroscopy (EDS) device, the Cr content is the highest among the metal elements in the Cr oxide. The Cr content is not particularly limited, but can be, for example, 20 mol % or more and 100 mol % or less.

It is preferable that the Cr content among the metal elements in the Cr oxide constituting the oxide adhesion layer 41 is 50 mol % or more. This makes it possible to significantly suppress the diffusion of Cr contained in the metal support 10 and the frame 20 to the oxide adhesion layer 41.

It is preferable that the Cr oxide constituting the oxide adhesion layer 41 is constituted by at least either chromium oxide or chromium manganese oxide. A property of these oxides is that the diffusion of Cr is particularly unlikely to occur, and therefore the durability of the oxide adhesion layer 41 can be improved.

One example of a chromium oxide is Cr₂O₃. Examples of chromium manganese oxides include MnCr₂O₄ (spinel) and Mn_{1,5}Cr_{1,5}O₄ (spinel).

It is preferable that the Cr oxide constituting the oxide adhesion layer 41 is crystalline. Accordingly, even when the electrolysis cell 1 is operated for a long period, it is possible to avoid the case where the oxide adhesion layer 41 becomes damaged due to a phase transition of the Cr oxide from amorphous to crystalline.

It is preferable that the Cr oxide constituting the oxide adhesion layer 41 has a spinel type or a corundum type crystal structure. These crystal structures are highly symmetrical, and therefore the thermal stress resistance of the oxide adhesion layer 41 can be improved. Also, Cr oxides having these crystal structures have good bonding properties at the interfaces with the metal support 10 and the frame 20, which are constituted by an alloy containing Cr, thus making it possible to improve the bonding strength between the oxide adhesion layer 41 and the metal support 10 and between the oxide adhesion layer 41 and the frame 20.

### [Metal Connection Portion 42]

Metal connection portions 42 are embedded in the oxide adhesion layer 41. The metal connection portions 42 are elongated along the thickness direction perpendicular to the first main surface 12 of the metal support 10. The metal connection portions 42 pass through the oxide adhesion layer 41 in the thickness direction. When viewed three-dimensionally, the metal connection portions 42 are columnar. The outer peripheral surfaces of the metal connection portions 42 are surrounded by the oxide adhesion layer 41.

The metal connection portions 42 connect the metal support 10 and the frame 20 to each other. One end of each of the metal connection portions 42 is connected to the metal support 10, and the other end of the metal connection portion 42 is connected to the frame 20. The metal connection portions 42 may be substantially integrated with at least either the metal support 10 or the frame 20.

By embedding the metal connection portions 42 in the oxide adhesion layer 41, cracks formed in the oxide adhesion layer 41 can be stopped at the metal connection portions 42. Therefore, brittle fracture of the oxide adhesion layer 41 can be suppressed, and the bond between the metal support 10 and the frame 20 can be maintained for a longer period of time.

Although three metal connection portions 42 are illustrated in FIG. 3, the number of metal connection portions 42 in one cross section is not particularly limited as long as it is one or more.

In FIG. 3, a metal connection portion 42 having a barrel-shaped cross section, a metal connection portion 42 having an inclined cross section, and a metal connection portion 42 having an hourglass-shaped cross section are illustrated in this order from left to right. When the cross section of the metal connection portion 42 is hourglass-shaped, the interfacial area between the metal support 10 and the metal connection portion 42 and between the frame 20 and the metal connection portion 42 can be increased, thereby improving the interfacial strength therebetween. When the cross section of the metal connection portion 42 is barrel-shaped or inclined, the volume of the metal connection portions 42 itself can be increased, and thus the crack stopping effect can be further improved.

Although the cross-sectional shapes of the metal connection portions 42 are different from one another in FIG. 3, the cross-sectional shapes of the metal connection portions 42 may be the same. Furthermore, the cross-sectional shapes of the metal connection portions 42 may be shapes other than the shapes shown in FIG. 3. It is preferable that the cross-sectional shape of each metal connection portion 42 is set taking into consideration a balance between improving the interfacial strength by increasing the interfacial area between the metal support 10 and the metal connection portion 42 and between the frame 20 and the metal connection portion 42, and improving the crack stopping effect by increasing the volume of the metal connection portion 42.

The metal connection portions 42 are constituted by a metal. It is preferable that the metal connection portions 42 contain, as a main component, the same element as the main component of at least either the metal support 10 or the frame 20. This makes it possible to suppress a change in composition of the metal connection portions 42 caused by element diffusion from the metal support 10 and the frame 20. For example, the metal connection portions 42 may contain Cr or Fe as a main component. Note that being contained as a main component means exhibiting the highest content percentage when the metal connection portions 42 are subjected to elemental analysis.

Moreover, it is preferable that the metal connection portions 42 contain Cr. This makes it possible to improve the oxidation resistance of the metal connection portions 42.

It is preferable that the ratio of a smallest width W1 of the metal connection portions 42 in the planar direction to the thickness of the oxide adhesion layer 41 in the thickness direction is 0.3 or more. This makes it possible to ensure the strength of the metal connection portions 42, and thus suppresses damage to the metal connection portions 42 caused by cracks. The planar direction is the direction perpendicular to the thickness direction.

The thickness of the adhesion layer 41 is the arithmetic average of the thicknesses of the oxide adhesion layer 41 at three locations that divide the oxide adhesion layer 41 into four equal parts in the planar direction. However, when the location where the thickness is to be measured overlaps with a metal connection portion 42, the thickness of the oxide adhesion layer 41 may be measured at any position close to that metal connection portion 42. The thickness of the adhesion layer 41 is not particularly limited, but may be, for example, 0.3 μm or more and 30 μm or less.

Moreover, the smallest width W1 of the metal connection portions 42 is the smallest measured value when the widths of the metal connection portions 42 in the planar direction is measured at 10 locations that divide the metal connection portions 42 into 11 equal parts in the thickness direction. The value of the smallest width W1 of the metal connection portions 42 is not particularly limited, but can be, for example, 0.05 μm or more and 5 μm or less.

It is preferable that, when a plurality of metal connection portions 42 are present, the ratio of the longest distance D1 between metal connection portions 42 in the planar direction to the thickness of the oxide adhesion layer 41 in the thickness direction is 20 or less. This allows the metal connection portions 42 to be arranged in a narrow range in the planar direction, thus making it possible to suppress the formation of long cracks in the oxide adhesion layer 41. As a result, it is possible to suppress peeling of the oxide adhesion layer 41 from the metal support 10 and the frame 20 caused by a long crack.

The longest distance D1 between metal connection portions 42 is the longest distance between two straight lines that are parallel to the thickness direction and inscribed in the contours of the side surfaces of each of two metal connection portions 42 that face each other. The value of the longest distance D1 is not particularly limited, but can be, for example, 1 μm or more and 100 μm or less.

It is preferable that the ratio of the thickness of the metal support 10 or the frame 20 in the thickness direction to the smallest width W1 of the metal connection portions 42 in the planar direction is 2000 or less. This makes it possible to suppress the case where the metal support 10 or the frame 20 is excessively thick (i.e., the metal connection portions 42 are excessively thin), thereby ensuring the strength of the metal connection portions 42.

It is preferable that the ratio of the thickness of the metal support 10 or the frame 20 in the thickness direction to the smallest width W1 of the metal connection portions 42 in the planar direction is 50 or more. This makes it possible to suppress the case where the metal support 10 or the frame 20 is excessively thin (i.e., the metal connection portions 42 are excessively thick), thereby making it possible to increase the rigidity of the first sealing portion 40.

It is preferable that the metal connection portions 42 are spaced apart from the internal space 3a. Specifically, it is preferable that the metal connection portions 42 are present in at least either the planar center portion or the planar outer peripheral portion. This makes it possible to suppress embrittling of the metal connection portions 42 caused by the reducing gas (H₂ in the present embodiment) flowing through the internal space 3a. The planar center portion is a portion located in the center when the oxide adhesion layer 41 is divided into three equal parts in the planar direction. The planar outer peripheral portion is a portion that is located on the external space 3b side of the planar center portion when the oxide adhesion layer 41 is divided into three equal parts in the planar direction.

The first sealing portion 40 can be formed as follows. First, a paste containing Cr oxide and metal particles is applied to the surface of at least either the metal support 10 or the frame 20. At this time, the amount of paste applied is adjusted such that the thickness of the applied paste is approximately the same as the average particle size of the metal particles. Next, the paste is fired to form the first sealing portion 40. The metal particles are connected to the metal support 10 and the frame 20 by element diffusion with the metal support 10 and the frame 20. The firing conditions can be appropriately set to, for example, 600° C. or more and 1100° C. or less and 0.5 hours or more to 24 hours or less.

### 2. Second Embodiment

### (Electrolysis Cell 1)

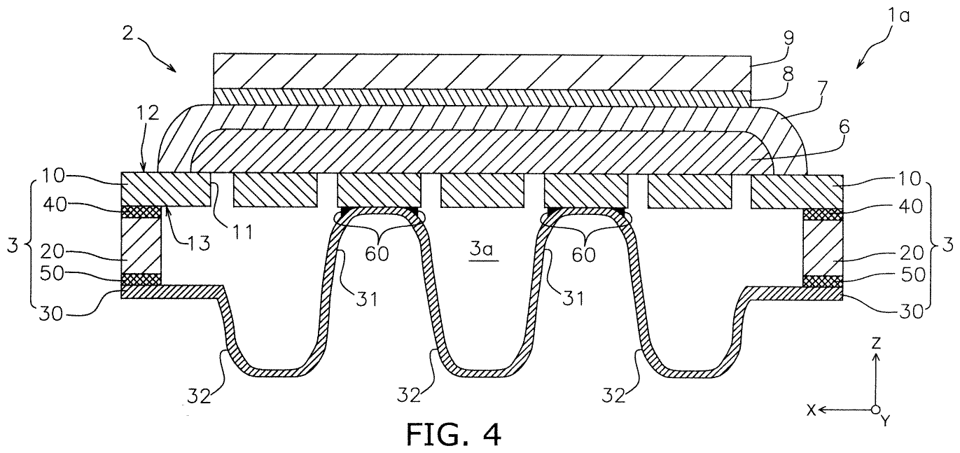

FIG. 4 is a cross-sectional view of an electrolysis cell 1a according to a second embodiment. The electrolysis cell 1a is an example of a “metal-supported electrochemical cell” according to the present invention.

The electrolysis cell 1a of the second embodiment differs from the electrolysis cell 1 of the first embodiment in that the interconnector 30 includes embossed portions 31 and debossed portions 32, and in that the chromium alloy container 3 includes bonding portions 60. The following mainly describes the differences.

In the present embodiment, either the metal support 10 or the interconnector 30 is an example of a “first alloy member” according to the present invention, and the other one is an example of a “second alloy member” according to the present invention. The bonding portions 60 are an example of an “interposing portion” according to the present invention.

As shown in FIG. 4, the interconnector 30 includes a plurality of embossed portions 31 and a plurality of debossed portions 32. In FIG. 4, two embossed portions 31 and three debossed portions 32 are shown, but the number of embossed portions 31 and the number of debossed portions 32 can be changed as appropriate.

The embossed portions 31 are in contact with the second main surface 13 of the metal support 10. As a result, the metal support 10 is supported by the interconnector 30, thus suppressing bending of the metal support 10. The embossed portions 31 only need to be in contact with the metal support 10 and do not need to be fixed to the metal support 10.

The debossed portions 32 protrude toward the side opposite to the metal support 10. The debossed portions 32 come into contact with an external power source or another electrolysis cell.

The bonding portions 60 bond the embossed portions 31 to the metal support 10. The bonding portions 60 are disposed in the vicinity of the leading end portions of the embossed portions 31. The leading end portion of the embossed portion 31 refers to the portion of the embossed portion 31 that comes into contact with the metal support 10. It is preferable that the bonding portions 60 are formed in a ring shape so as to surround the leading end portions of the embossed portions 31. This makes it possible to improve the bond between the embossed portions 31 and the metal support 10.

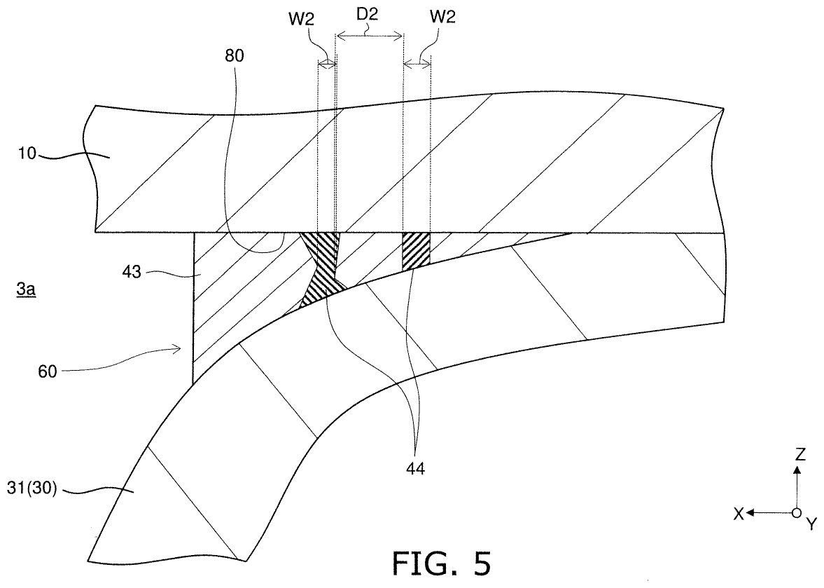

Here, FIG. 5 is an enlarged view of a portion of FIG. 4. A cross section of one bonding portion 60 is shown in FIG. 5. The cross section illustrated in FIG. 5 is perpendicular to the second main surface 13 of the metal support 10.

The bonding portion 60 is disposed between the metal support 10 and the embossed portion 31. The bonding portion 60 is sandwiched between the metal support 10 and the embossed portion 31. The bonding portion 60 is disposed on the metal support 10 and is formed in an annular shape so as to surround the leading end portion of the embossed portion 31.

In the present embodiment, the bonding portion 60 is embedded in a bottomed recess 80 formed between the metal support 10 and the embossed portion 31. The cross section of the bottomed recess 80 is wedge-shaped. The bonding portion 60 is exposed to the internal space 3a.

The bonding portion 60 includes an oxide adhesion layer 43 and metal connection portions 44.

### [Oxide Adhesion Layer 43]

The oxide adhesion layer 43 is disposed between the metal support 10 and the embossed portion 31. The oxide adhesion layer 43 is sandwiched between the metal support 10 and the embossed portion 31. The oxide adhesion layer 43 is formed in an annular shape so as to surround the leading end portion of the embossed portion 31. The oxide adhesion layer 43 is exposed to the internal space 3a.

The oxide adhesion layer 43 is constituted by Cr oxide. This makes it possible to suppress the diffusion of Cr from the metal support 10 and the embossed portion 31 to the oxide adhesion layer 43 during the manufacture and operation of the electrolysis cell 1. Furthermore, even if Cr diffuses from the metal support 10 and the embossed portion 31 to the oxide adhesion layer 43, the effect on the composition of the oxide adhesion layer 43 is small, thus making it possible to suppress a decrease in the strength of the oxide adhesion layer 43. Furthermore, since the metal support 10, the embossed portion 31, and the oxide adhesion layer 43 all contain Cr, the bond therebetween can be improved. Therefore, the bond between the metal support 10 and the embossed portion 31 can be maintained for a long period of time.

It is preferable that the Cr content among the metal elements in the Cr oxide constituting the oxide adhesion layer 43 is 50 mol % or more. This makes it possible to significantly suppress the diffusion of Cr contained in the metal support 10 and the embossed portion 31 to the oxide adhesion layer 43.

It is preferable that the Cr oxide constituting the oxide adhesion layer 43 is constituted by at least either chromium oxide or chromium manganese oxide. A property of these oxides is that the diffusion of Cr is particularly unlikely to occur, and therefore the durability of the oxide adhesion layer 43 can be improved.

It is preferable that the Cr oxide constituting the oxide adhesion layer 43 is crystalline. Accordingly, even when the electrolysis cell 1 is operated for a long period, it is possible to avoid the case where the oxide adhesion layer 43 becomes damaged due to a phase transition of the Cr oxide from amorphous to crystalline.

It is preferable that the Cr oxide constituting the oxide adhesion layer 43 has a spinel or corundum type crystal structure. These crystal structures are highly symmetrical, and therefore the thermal stress resistance of the oxide adhesion layer 43 can be improved. Also, Cr oxides having these crystal structures have good bonding properties at the interfaces with the metal support 10 and the embossed portion 31, which are constituted by an alloy containing Cr, and therefore can improve the bonding strength between the oxide adhesion layer 43 and the metal support 10 and between the oxide adhesion layer 43 and the embossed portion 31.

### [Metal Connection Portion 44]

The metal connection portions 44 are embedded in the oxide adhesion layer 43. The metal connection portions 44 are elongated along the thickness direction perpendicular to the first main surface 12 of the metal support 10. The metal connection portions 44 pass through the oxide adhesion layer 43 in the thickness direction. When viewed three-dimensionally, the metal connection portions 44 are columnar. The side surfaces of the metal connection portions 44 are surrounded by the oxide adhesion layer 43.

The metal connection portions 44 connect the metal support 10 and the embossed portion 31 to each other. One end of each of the metal connection portions 44 is connected to the metal support 10, and the other end of the metal connection portion 44 is connected to the embossed portion 31. The metal connection portions 44 may be substantially integrated with at least either the metal support 10 or the embossed portion 31.

By embedding the metal connection portions 44 in the oxide adhesion layer 43, cracks formed in the oxide adhesion layer 43 can be stopped at the metal connection portions 44. Therefore, brittle fracture of the oxide adhesion layer 43 can be suppressed, and the bond between the metal support 10 and the embossed portion 31 can be maintained for a longer period of time.

Although two metal connection portions 44 are illustrated in FIG. 5, the number of metal connection portions 44 in one cross section is not particularly limited as long as it is one or more.

In FIG. 5, a metal connection portion 44 having an hourglass-shaped cross section and a metal connection portion 44 having a straight cross section are shown in this order from left to right. Although the cross-sectional shapes of the metal connection portions 44 are different from one another in FIG. 5, the cross-sectional shapes of the metal connection portions 44 may be the same. Furthermore, the cross-sectional shapes of the metal connection portions 44 may be shapes other than the shapes shown in FIG. 5.

The metal connection portions 44 are constituted by a metal. It is preferable that the metal connection portions 44 contain, as a main component, the same element as the main component of at least either the metal support 10 or the embossed portion 31. This makes it possible to suppress a change in composition of the metal connection portions 44 caused by element diffusion from the metal support 10 and the embossed portion 31. For example, the metal connection portions 44 may contain Cr or Fe as a main component.

Moreover, it is preferable that the metal connection portions 44 contain Cr. This makes it possible to improve the oxidation resistance of the metal connection portions 44.

It is preferable that the ratio of a smallest width W2 of the metal connection portions 44 in the planar direction to the thickness of the oxide adhesion layer 43 in the thickness direction is 0.3 or more. This makes it possible to ensure the strength of the metal connection portions 44, and thus suppresses damage to the metal connection portions 44 caused by cracks. The planar direction is the direction perpendicular to the thickness direction.

The thickness of the adhesion layer 43 is the arithmetic average of the thicknesses of the oxide adhesion layer 43 at three locations that divide the oxide adhesion layer 43 into four equal parts in the planar direction. However, when the location where the thickness is to be measured overlaps with a metal connection portion 44, the thickness of the oxide adhesion layer 43 may be measured at any position close to that metal connection portion 44. The thickness of the adhesion layer 43 is not particularly limited, but may be, for example, 0.3 μm or more and 30 μm or less.

Moreover, the smallest width W2 of the metal connection portions 44 is the smallest measured value when the widths of the metal connection portions 44 in the planar direction is measured at 10 locations that divide the metal connection portions 44 into 11 equal parts in the thickness direction. The value of the smallest width W2 of the metal connection portions 44 is not particularly limited, but can be, for example, 0.05 μm or more and 5 μm or less.

It is preferable that, when a plurality of metal connection portions 44 are present, the ratio of the longest distance D2 between metal connection portions 44 in the planar direction to the thickness of the oxide adhesion layer 43 in the thickness direction is 20 or less. This allows the metal connection portions 44 to be arranged in a narrow range in the planar direction, thus making it possible to suppress the formation of long cracks in the oxide adhesion layer 43. As a result, it is possible to suppress peeling of the oxide adhesion layer 43 from the metal support 10 and the embossed portion 31 caused by a long crack.

The longest distance D2 between metal connection portions 44 is the longest distance between two straight lines that are parallel to the thickness direction and inscribed in the contours of the side surfaces of each of two metal connection portions 44 that face each other. The value of the longest distance D2 is not particularly limited, but can be, for example, 1 μm or more and 100 μm or less.

It is preferable that the ratio of the thickness of the metal support 10 or the embossed portion 31 in the thickness direction to the smallest width W2 of the metal connection portions 44 in the planar direction is 2000 or less. This makes it possible to suppress the case where the metal support 10 or the embossed portion 31 is excessively thick (i.e., the metal connection portions 44 are excessively thin), thereby ensuring the strength of the metal connection portions 44.

It is preferable that the ratio of the thickness of the metal support 10 or the embossed portion 31 in the thickness direction to the smallest width W2 of the metal connection portions 44 in the planar direction is 50 or more. This makes it possible to suppress the case where the metal support 10 or the embossed portion 31 is excessively thin (i.e., the metal connection portions 44 are excessively thick), thereby making it possible to increase the rigidity of the bonding portion 60.

It is preferable that the metal connection portions 44 are spaced apart from the internal space 3a. Specifically, it is preferable that the metal connection portions 44 are present in at least either the planar center portion or the planar inner peripheral portion. This makes it possible to suppress embrittling of the metal connection portions 44 caused by the reducing gas (H₂ in the present embodiment) flowing through the internal space 3a. The planar center portion is a portion located in the center when the oxide adhesion layer 43 is divided into three equal parts in the planar direction. The planar inner peripheral portion is a portion that is located on the side of the planar center portion opposite to the internal space 3a side when the oxide adhesion layer 43 is divided into three equal parts in the planar direction.

The bonding portion 60 can be formed as follows. First, a paste containing Cr oxide and metal particles is applied to the surface of at least either the metal support 10 or the embossed portion 31. At this time, the amount of paste applied is adjusted such that the thickness of the applied paste is approximately the same as the average particle size of the metal particles. The paste is then fired to form the bonding portion 60. The metal particles are connected to the metal support 10 and the embossed portion 31 by element diffusion with the metal support 10 and the embossed portion 31. The firing conditions can be appropriately set to, for example, 600° C. or more and 1100° C. or less and 0.5 hours or more to 24 hours or less.

### (Variations)

Although embodiments of the present invention have been described above, the present invention is not limited to these embodiments, and various modifications can be made without departing from the spirit of the present invention.

### [Variation 1]

In the first and second embodiments, the frame 20 and the interconnector 30 are separate members, but the frame 20 and the interconnector 30 may be an integrated member. In this case, the chromium alloy container 3 does not include the second sealing portion 50.

### [Variation 2]

In the first and second embodiments, the metal support 10 and the frame 20 are separate members, but the metal support 10 and the frame 20 may be an integrated member. In this case, the chromium alloy container 3 does not include the first sealing portion 40.

### [Variation 3]

In the first and second embodiments, the oxide adhesion layer 41 has a single-layer structure, but there is no limitation to this. The oxide adhesion layer 41 may have a multi-layer structure including two or more layers constituted by Cr oxides having different compositions.

### [Variation 4]

In the second embodiment, the oxide adhesion layer 43 has a single-layer structure, but there is no limitation to this. The oxide adhesion layer 43 may have a multi-layer structure including two or more layers constituted by Cr oxides having different compositions.

### [Variation 5]

In the first embodiment, the metal support 10 and the frame 20 may be partially welded or brazed. In this case, the first sealing portion 40 may be divided in the planar direction by welding or brazing the metal support 10 and the frame 20 together.

In the first embodiment, the frame 20 and the interconnector 30 may be partially welded or brazed. In this case, the second sealing portion 50 may be divided in the planar direction by welding or brazing the frame 20 and the interconnector 30.

In the second embodiment, the metal support 10 and the embossed portion 31 may be partially welded or brazed. In this case, the bonding portion 60 may be divided in the planar direction by welding or brazing the metal support 10 and the embossed portion 31.

### [Variation 6]

In the above embodiments, an electrolysis cell has been described as an example of an electrochemical cell, but the electrochemical cell is not limited to an electrolysis cell. An electrochemical cell is a general term for an element in which a pair of electrodes are arranged so that electromotive force is produced from an overall oxidation-reduction reaction in order to convert electrical energy into chemical energy, and for an element for converting chemical energy into electrical energy. Thus, electrochemical cells include, for example, fuel cells that use oxide ions or protons as carriers.

### [Variation 7]

In the above embodiments, the chromium alloy container according to the present invention is applied to an electrochemical cell, but the chromium alloy container can be used for various purposes. The chromium alloy container can be applied to, for example, a methanation reactor for synthesizing methane from hydrogen and carbon dioxide.

### [Working Examples]

Working examples of the chromium alloy container according to the present invention will be described below. However, the present invention is not limited to the working examples described below.

### (Samples No. 1 to 5)

Chromium alloy containers 3 (see FIG. 3) according to Samples No. 1 to 5 were manufactured as follows.

First, for each sample, a paste containing Cr₂O₃ and metal particles (specifically, SUS430 particles) was applied to the outer peripheral portion of the second main surface 13 of the metal support 10, and then the frame 20 was placed on the paste to produce a laminate. At this time, the smallest width W1 of the metal connection portions 42 was varied by changing the particle size of the metal particles.

Next, the laminate was subjected to a heat treatment (1000° C., 1 hour) such that the first sealing portion 40 constituted by the oxide adhesion layer 41 and the metal connection portions 42 was formed from the paste. As a result, the chromium alloy container 3 having the first sealing portion 40 was obtained.

Next, the chromium alloy container 3 was subjected to a thermal cycle test in which a process of increasing the temperature from room temperature to 800° C. at a temperature increase rate of 200° C./hr and then decreasing the temperature from 800° C. to room temperature at a temperature decrease rate of 200° C./hr was repeated 10 times.

Next, the chromium alloy container 3 was cut along the thickness direction to expose a cross section of the first sealing portion 40 along the thickness direction.

Next, as described in the above embodiments, the cross section of the first sealing portion 40 was observed with an SEM (5000 times magnification) to measure the ratio of the smallest width W1 of the metal connection portions 42 to the thickness of the oxide adhesion layer 41. The results of the ratio measurements are shown in Table 1.

Next, the cross section of the first sealing portion 40 was observed with an SEM (5000 times magnification) to check for the presence or absence of cracks at the joints between the metal connection portions 42 and the metal support 10 and between the metal connection portions 42 and the frame 20. The crack results are shown in Table 1.

TABLE 1

| | Smallest width of metal connection | |
|---|---|---|
| Sample | portions 42/thickness of oxide | |
| No. | adhesion layer 41 | Crack |
| 1 | 0.3 | No |
| 2 | 0.5 | No |
| 3 | 1.0 | No |
| 4 | 2.0 | No |
| 5 | 0.2 | Yes |

As shown in Table 1, in Samples No. 1 to 4 in which the ratio of the smallest width W1 of the metal connection portions 42 to the thickness of the oxide adhesion layer 41 was 0.3 or more, the formation of cracks at the joints between the metal connection portions 42 and the metal support 10 and between the metal connection portions 42 and the frame 20 was suppressed. Based on this, it was found that by setting the ratio of the smallest width W1 of the metal connection portions 42 to the thickness of the oxide adhesion layer 41 to 0.3 or more, it was possible to ensure the strength of the metal connection portions 42.

Although not shown in Table 1, results the same as those for the first sealing portion 40 were obtained for the second sealing portion 50.

### (Samples No. 6 to 10)

Chromium alloy containers 3 (see FIG. 3) according to Samples No. 6 to 10 were manufactured as follows.

First, for each sample, a paste containing Cr₂O₃ and metal particles (specifically, SUS430 particles) was applied to the outer peripheral portion of the second main surface 13 of the metal support 10, and then the frame 20 was placed on the paste to produce a laminate. At this time, the longest distance D1 between metal connection portions 42 was varied by changing the amount of metal particles added.

Next, the laminate was subjected to a heat treatment (1000° C., 1 hour) such that the first sealing portion 40 constituted by the oxide adhesion layer 41 and the metal connection portions 42 was formed from the paste. As a result, the chromium alloy container 3 having the first sealing portion 40 was obtained.

Next, the chromium alloy container 3 was subjected to a thermal cycle test in which a process of increasing the temperature from room temperature to 800° C. at a temperature increase rate of 200° C./hr and then decreasing the temperature from 800° C. to room temperature at a temperature decrease rate of 200° C./hr was repeated 10 times.

Next, the chromium alloy container 3 was cut along the thickness direction to expose a cross section of the first sealing portion 40 along the thickness direction.

Next, as described in the above embodiments, the cross section of the first sealing portion 40 was observed with an SEM (5000 times magnification) to measure the ratio of the longest distance D1 between metal connection portions 42 to the thickness of the oxide adhesion layer 41. The results of the ratio measurements are shown in Table 2.

Next, the cross section of the first sealing portion 40 was observed using an SEM (5000 times magnification magnification) to check for the occurrence of localized peeling of the oxide adhesion layer 41 from the metal support 10 and the frame 20 in the vicinity of a crack that formed in the oxide adhesion layer 41. The peeling results are shown in Table 2.

TABLE 2

| | Longest distance D1 between metal | |
|---|---|---|
| Sample | connection portions 42/thickness of | |
| No. | oxide adhesion layer 41 | Peeling |
| 6 | 20 | No |
| 7 | 10 | No |
| 8 | 5 | No |
| 9 | 1 | No |
| 10 | 30 | Yes |

As shown in Table 2, in Samples No. 6 to 9 in which the ratio of the longest distance D1 between metal connection portions 42 to the thickness of the oxide adhesion layer 41 was set to 20 or less, peeling of the oxide adhesion layer 41 could be suppressed. Based on this, it was found that by setting the ratio of the longest distance D1 between metal connection portions 42 to the thickness of the oxide adhesion layer 41 to 20 or less, it is possible to suppress localized peeling caused by a crack in the oxide adhesion layer 43.

Although not shown in Table 2, results the same as those for the first sealing portion 40 were obtained for the second sealing portion 50.

### (Samples No. 11 to 18)

Chromium alloy containers 3 (see FIG. 3) according to Samples No. 11 to 18 were manufactured as follows.

First, for each sample, a paste containing Cr₂O₃ and metal particles (specifically, SUS430 particles) was applied to the outer peripheral portion of the second main surface 13 of the metal support 10, and then the frame 20 was placed on the paste to produce a laminate. At this time, the smallest width W1 of the metal connection portions 42 was varied by changing the particle size of the metal particles.

Next, the laminate was subjected to a heat treatment (1000° C., 1 hour) such that the first sealing portion 40 constituted by the oxide adhesion layer 41 and the metal connection portions 42 was formed from the paste. As a result, the chromium alloy container 3 having the first sealing portion 40 was obtained.

Next, the chromium alloy container 3 was subjected to a thermal cycle test in which a process of increasing the temperature from room temperature to 800° C. at a temperature increase rate of 200° C./hr and then decreasing the temperature from 800° C. to room temperature at a temperature decrease rate of 200° C./hr was repeated 10 times.

Next, the chromium alloy container 3 was cut along the thickness direction to expose a cross section of the first sealing portion 40 along the thickness direction.

Next, as described in the above embodiments, the ratio of the thickness of the metal support 10 to the smallest width W1 of the metal connection portions 42 was measured. The results of the ratio measurements are shown in Table 3.

Next, the cross section of the first sealing portion 40 was observed with an SEM (5000 times magnification) to check for the presence or absence of cracks at the joints between the metal connection portions 42 and the metal support 10 and between the metal connection portions 42 and the frame 20. The crack results are shown in Table 3.

Next, the amount of flexure of the first sealing portion 40 was measured using a three-dimensional shape measuring device. The flexure amount measurement results are shown in Table 3.

TABLE 3

| | Thickness of metal support 10/ | | Flexure |
|---|---|---|---|
| Sample | smallest width W1 of metal | | amount |
| No. | connection portions 42 | Crack | (mm) |
| 11 | 10 | No | 13 |
| 12 | 50 | No | 1.6 |
| 13 | 100 | No | 1.2 |
| 14 | 200 | No | 1.0 |
| 15 | 500 | No | 0.8 |
| 16 | 1000 | No | 0.7 |
| 17 | 2000 | No | 0.6 |
| 18 | 2500 | Yes | 0.5 |

As shown in Table 3, in Samples No. 11 to 17 in which the ratio of the thickness of the metal support 10 to the smallest width W1 of the metal connection portions 42 was set to 2000 or less, it was possible to suppress the formation of cracks at the joints between the metal connection portions 42 and the metal support 10 and between the metal connection portions 42 and the frame 20. Based on this, it was found that by setting the ratio of the thickness of the metal support 10 to the smallest width W1 of the metal connection portions 42 to be 2000 or less, it was possible to ensure the strength of the metal connection portions 42.

Furthermore, as shown in Table 3, in Samples No. 12 to 18 in which the ratio of the thickness of the metal support 10 to the smallest width W1 of the metal connection portions 42 was 50 or more, it was possible to suppress the amount of flexure of the first sealing portion 40. Based on this, it was found that by setting the ratio of the thickness of the metal support 10 to the smallest width W1 of the metal connection portions 42 to 50 or more, it was possible to increase the rigidity of the first sealing portion 40.

Although not shown in Table 3, results the same as those for the first sealing portion 40 were obtained for the second sealing portion 50.

### REFERENCE SIGNS LIST

1, 1a Electrolysis cell
2 Cell body portion
3 Chromium alloy container
3a Internal space
6 Hydrogen electrode
7 Electrolyte
8 Reaction prevention layer
9 Oxygen electrode
10 Metal support
11 Supply hole
12 First main surface
13 Second main surface
20 Frame
30 Interconnector
31 Embossed portion
40 First sealing portion
41, 43 Oxide adhesion layer
42, 44 Metal connection portion
50 Second sealing portion
60 Bonding portion

1. A chromium alloy container having an internal space, comprising:
a first alloy member constituted by an alloy containing chromium;
a second alloy member constituted by an alloy containing chromium; and
an interposing portion interposed between the first alloy member and the second alloy member, wherein
the interposing portion includes
an oxide adhesion layer constituted by an oxide containing chromium as a main component, and
a metal connection portion embedded in the oxide adhesion layer and connecting the first alloy member and the second alloy member to each other.

2. The chromium alloy container according to claim 1, wherein
the metal connection portion contains, as a main component, an element corresponding to a main component of at least either the first alloy member or the second alloy member.

3. The chromium alloy container according to claim 1, wherein
the metal connection portion contains chromium.

4. The chromium alloy container according to claim 1, wherein
a ratio of a smallest width of the metal connection portion in a planar direction to a thickness of the oxide adhesion layer in a thickness direction is 0.3 or more.

5. The chromium alloy container according to claim 1, wherein
a ratio of a longest distance between the metal connection portions in a planar direction to a thickness of the oxide adhesion layer in a thickness direction is 20 or more.

6. The chromium alloy container according to claim 1, wherein
a ratio of a thickness of the first alloy member or the second alloy member in a thickness direction to a smallest width of the metal connection portion in a planar direction is 50 or more.

7. The chromium alloy container according to claim 1, wherein
a ratio of a thickness of the first alloy member or the second alloy member in a thickness direction to a smallest width of the metal connection portion in a planar direction is 2000 or less.

8. The chromium alloy container according to claim 1, wherein
a chromium content among metal elements in the oxide adhesion layer is 50 mol % or more.

9. The chromium alloy container according to claim 1, wherein
the oxide adhesion layer is constituted by at least either chromium oxide or chromium manganese oxide.

10. The chromium alloy container according to claim 1, wherein
the oxide adhesion layer is crystalline.

11. The chromium alloy container according to claim 10, wherein
the oxide adhesion layer has a spinel type crystal structure or a corundum type crystal structure.

12. The chromium alloy container according to claim 1, wherein
the interposing portion is a seal for sealing the internal space.

13. The chromium alloy container according to claim 1, wherein
the second alloy member has an embossed portion in contact with the first alloy member, and
the interposing portion adheres the embossed portion to the first alloy member.

14. A metal-supported electrochemical cell comprising:
the chromium alloy container according to claim 1; and
a cell body portion disposed on the chromium alloy container, wherein
the first alloy member has a plurality of communication holes in communication with the internal space, and
the cell body portion is disposed on the first alloy member in such a manner as to cover the plurality of communication holes.
